(19) United States
(12) Patent Application Publication
(10) Pub. No.: US 2003/0106757 A1
(43) Pub. Date: Jun. 12, 2003

(54) Power door clutch assembly

(76) Inventors: Joseph M. Johnson, Troy, MI (US); Sothy Chhe, Long Beach, CA (US)

Correspondence Address: Kathryn A Marra, Delphi Technologies Inc, Legal Staff - M/C: 480-414-420, P O Box 5052, Troy, MI, 48007-5052, US

(21) Appl. No.: 10/013,154

(22) Filed: Dec. 10, 2001

(51) Int. Cl. F16D 27/14

(52) U.S. Cl. 192/30 W; 192/84.1

(57) ABSTRACT

A power door clutch assembly including a motor that has a shaft operably connected to the motor. The clutch assembly also includes a clutch having a rotor associated with the shaft to provide rotational movement to the rotor. A stator is also provided that is positioned in juxtaposition to the rotor. A housing surrounds the clutch and includes an adjustable hall-effect sensor fixture that includes hall-effect sensors for allowing measurement of an angular speed of the clutch assembly.

### FIELD OF THE INVENTION

The subject invention relates to clutch assemblies for power doors on a vehicle, and more particularly to a clutch assembly for a power sliding door that includes an adjustable hall-effect sensor fixture for detecting an angular speed of the clutch assembly.

### BACKGROUND OF THE INVENTION

Power doors including power sliding doors, as well as power liftgates are becoming more common in the automobile industry. Such power doors typically include clutch assemblies for selectively transferring torque from a motor to the door units. Control mechanisms are usually utilized to control the engagement of the clutch assembly.

As a function of such control mechanisms, the angular speed of the motor or clutch is commonly measured and utilized in a control system. Currently, the angular speed of the motor or clutch is commonly measured using optical speed encoders. These optical encoders consist of a plastic disk that is interfaced with the motor shaft through a gear train. The disk usually rests between a pair of infrared emitter detectors which counts the number of notches on the perimeter of the disk as the motor turns.

Despite their effectiveness, existing optical speed encoders remain mechanically complex and require interfacing mechanisms as well as occupy a large operating space within a clutch assembly. In many situations, an extra gear train is needed to interface with a gear that is attached to the motor to provide an optical sensing system. The resulting optical sensing system is a complex system that includes redundant gear trains and encoder mechanisms. Therefore, there is a need in the art for a clutch assembly that is less complex, such that it is easier to manufacture and assemble. There is also a need in the art to provide a clutch assembly with less components that will increase the reliability of such a clutch system, as well as, lead to cost savings of the clutch assembly and the overall vehicle.

### SUMMARY OF THE INVENTION

A power door clutch assembly including a motor that has a shaft operably coupled to the motor. The clutch also includes a clutch rotor that is associated with the shaft for providing rotational movement to the rotor. The power door clutch assembly further includes a stator that is positioned in juxtaposition to the rotor. Surrounding the clutch assembly is a housing that includes an adjustable hall-effect sensor fixture having at least two hall-effect sensors. The hall-effect sensors allow for measurement of an angular speed of the clutch assembly.

The power door clutch assembly of the present invention has the advantage of providing a means for measuring an angular speed of the clutch assembly without the use of optical encoders which are mechanically complex and add to the overall expense of the clutch assembly.

### BRIEF DESCRIPTION OF THE DRAWINGS

These and other features and advantages of the present invention will become more readily appreciated when considered in connection with the following detailed description and appended drawings, where:

FIG. 1 is a perspective view showing the clutch assembly of the present invention;

FIG. 2 is a perspective view of the rotor and stator including the speed encoder grooves of the present invention.

### DETAILED DESCRIPTION OF THE PREFERRED EMBODIMENT

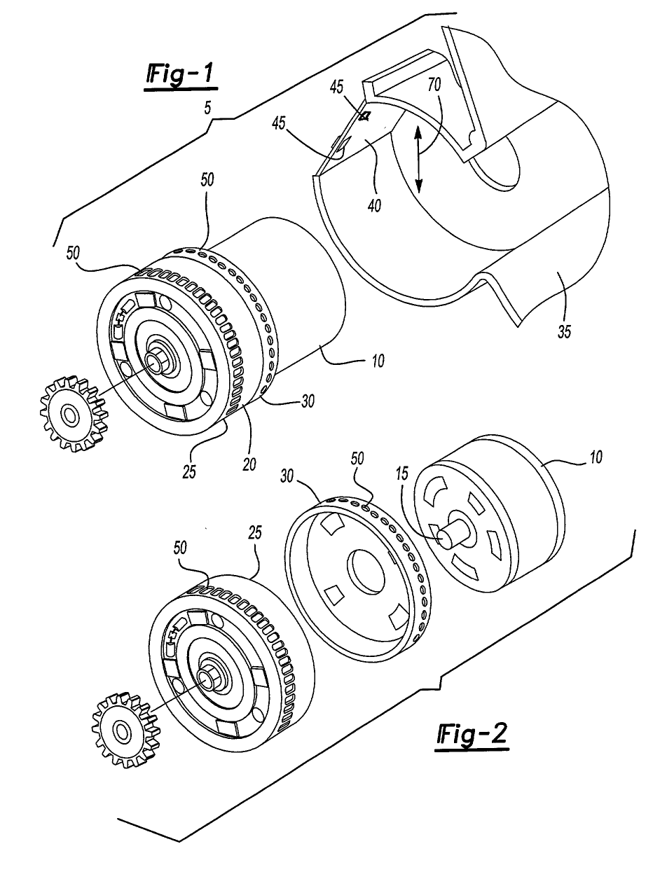

With reference to FIG. 1, there is shown the power door clutch assembly 5 of the present invention. The power door clutch assembly 5 includes a motor 10 having a shaft 15 that is coupled to the motor 10. There is also included a clutch 20 having a clutch rotor 25 associated with the shaft 15 to provide rotational movement to the rotor 25. There is also a stator 30 positioned in juxtaposition to the rotor 25. A housing 35 surrounds the clutch 20 to protect the clutch from intrusion from an outside source, as well as, provides a location for an adjustable hall-effect sensor fixture 40.

Again, with reference to FIG. 1, there is shown a preferred embodiment of the power door clutch assembly 5 that is used in a power sliding door application. As can be seen from FIG. 1, the motor 10 is positioned at a top of the housing 35 which encloses a clutch 20. A shaft 15 extends from the motor 10 through the housing 35 and is associated with the clutch rotor 25 for providing rotational movement to the rotor 25.

As can be seen in FIG. 1, the clutch 20 is disposed within the housing 35 such that there is a gap 70 formed between the clutch 20 and the housing 35. This gap 70 provides a clearance between speed encoder grooves 50 and the hall-effect sensors 45 which will be discussed in more detail below. Preferably, the gap 70 between the clutch 20 and the housing 35 is at least 2 millimeters in size.

With reference to FIG. 1, there is shown an adjustable hall-effect sensor fixture 40 disposed on the housing 35. The adjustable hall-effect sensor fixture 40 includes at least two hall-effect sensors 45 to allow for the measurement of an angular speed of the clutch assembly 5. The adjustable hall-effect sensor fixture 40 includes the appropriate circuitry that is connected with a control module (not shown) for adjusting the engagement of the clutch assembly 5 based on the relative angular speed of the clutch assembly 5, as well as other variables. As stated above, the adjustable hall-effect sensor fixture 40 includes at least two hall-effect sensors 45 and preferably two hall-effect sensors 45 with a 90 degree phase difference or quadrature. The sensors 45 are preferably associated with the grooves 50 on the rotor 25, as shown in FIG. 1, but may be associated with the grooves 50 on the stator 30, in an alternative embodiment.

With reference to FIG. 2, there is shown the rotor 25 and stator 30 isolated from the rest of the clutch assembly 5. Either of the rotor 25 or stator 30 includes speed encoder grooves 50 formed around a periphery 55, 60 respectively for the rotor and stator. Depending on the type of clutch being utilized, the angular speed of the clutch assembly 5 may be measured based on the rotation of the rotor 25 or stator 30.

As can be seen in FIG. 2, the speed encoder grooves 50 of the rotor 25 have an elliptical shape and are disposed circumferentially around the periphery of the rotor 20. The slots are designed such that they generate a magnetic flux that is perpendicular to the hall-effect sensors 45.

Again, with reference to FIG. 2, the speed encoder grooves 50 of the stator 30 are of a generally circular shape, and are disposed circumferentially around the periphery 60 of the stator, similar to the design of the speed encoder grooves 50 of the rotor 20. As with the speed encoder grooves 50 of the rotor 20, the speed encoder grooves 50 of the stator 30 produce a magnetic flux that is perpendicular to the hall-effect sensors 45.

The flux field generated by the speed encoder grooves 50 on either of the rotor 25 or stator 30 is perpendicular to the hall-effect sensors 45, such that any other magnetic fields produced are not detected by the hall-effect sensors 45. For example a clutch coil that is used to energize the clutch assembly 5 may produce a flux that is parallel to the hall-effect sensors 45 and is therefor, not detected by the hall-effect sensors 45. In this manner, the measurement of the angular speed of the clutch assembly 5 will not exhibit discrepancies from other magnetic fluxes produced by the clutch assembly 5.

The clutch assembly 5 including the speed encoder grooves 50 are designed to produce a 50% duty cycled digital output from the hall-effect sensors 45 that is analyzed by a control module (not shown) such that the clutch assembly 5 may be adjusted accordingly. As referenced above, only two hall-effect sensors 45 with a 90° phase difference are required to produce the preferred 50% duty cycle digital output, although any number of hall-effect sensors 45 may be utilized by the present invention.

In use, as the rotor 20 or stator turns, a magnetic flux is generated that is perpendicular to the hall-effect sensors 45. The digital signal sent from the hall-effect sensors 45 to a control module (not shown) allows for the calculation of an angular speed of the clutch assembly 5. The angular speed, in turn, may be used for various applications including engaging or disengaging the clutch assembly when an obstruction is present in a door that is to be opened or closed. In this manner, damage to the clutch assembly can be prevented by disengaging the clutch assembly.

While a preferred embodiment is disclosed, a worker in this art would understand that various modifications would come within the scope of the invention. Thus, the following claims should be studied to determine the true scope and content of this invention.

In the claims:

1. A power door clutch assembly comprising:
a motor having a shaft operably coupled to the motor;
a clutch including a clutch rotor associated with the shaft for providing rotational movement to the rotor and a stator in juxtaposition to the rotor;
a housing surrounding the clutch;
said housing including an adjustable hall-effect sensor fixture including at least two hall-effect sensors and wherein the hall effect sensors allow for measurement of an angular speed of the clutch assembly.

2. The power door clutch assembly of claim 1 wherein the hall-effect sensors detect a magnetic flux perpendicular to the sensors.

3. The power door clutch assembly of claim 1 wherein either of the rotor or stator includes speed encoder grooves formed around a periphery thereof.

4. The power door clutch assembly of claim 3 wherein the rotor includes speed encoder grooves formed around a periphery thereof.

5. The power door clutch assembly of claim 3 wherein the stator includes speed encoder grooves formed around a periphery thereof.

6. The power sliding door clutch assembly of claim 3 wherein the hall-effect sensors detect a magnetic flux generated by the speed encoder grooves.

7. The power door clutch assembly of claim 3 wherein the speed encoder grooves are of such geometry that the magnetic flux produced by the speed encoder grooves is perpendicular to the hall-effect sensors.

8. The power door clutch assembly of claim 3 wherein the speed encoder grooves are of such geometry that there is at least a two-millimeter gap between the hall-effect sensors and the speed encoder grooves.

9. The power sliding clutch assembly of claim 3 wherein the speed encoder grooves are designed to produce a 50 percent duty cycle digital output from the hall-effect sensors.

10. The power door clutch assembly of claim 9 wherein the hall-effect fixture includes two hall-effect sensors with a 90 degree phase difference.

11. The power door clutch assembly of claim 1 wherein a clutch coil produces a magnetic flux parallel to the hall-effect sensors that is not detected by the hall-effect sensors.

12. A power door clutch assembly comprising:
a motor having a shaft operably coupled to the motor;
a clutch including a clutch rotor associated with the shaft for providing rotational movement to the rotor and a stator in juxtaposition to the rotor;
a housing surrounding the clutch;
said housing including an adjustable hall-effect sensor fixture including at least two hall-effect sensors wherein the hall-effect sensors detect a magnetic flux perpendicular to the sensors to allow for measurement of an angular speed of the clutch assembly.

13. A power door clutch assembly comprising:
a motor having a shaft operably coupled to the motor;
a clutch including a rotor associated with the shaft for providing rotational movement to the rotor, and a stator in juxtaposition to the rotor, said rotor or stator including speed encoder grooves formed around a periphery thereof;
a housing surrounding the clutch;
said housing including an adjustable hall-effect sensor fixture including at least two hall-effect sensors wherein the hall-effect sensors detect a magnetic flux generated by the speed encoder grooves to allow for measurement of an angular speed of the clutch assembly.
